(19) United States
(12) Patent Application Publication
(10) Pub. No.: US 2021/0262580 A1
(43) Pub. Date: Aug. 26, 2021

(54) PILOT OPERATED FLOW CONTROL VALVES

(71) Applicant: WALNAB PTY LTD, New South Wales (AU)

(72) Inventors: Adam Peattie, New South Wales (AU); Dean Norris, New South Wales (AU)

(21) Appl. No.: 17/268,506

(22) PCT Filed: Aug. 28, 2019
(86) PCT No.: PCT/AU2019/050911

§ 371 Date: Feb. 15, 2021

(30) Foreign Application Priority Data
Aug. 29, 2018 (AU) 2018903182

(51) Int. Cl. F16K 21/18; F16K 31/122; F16K 17/24; B67D 7/36; B60K 15/035

(52) U.S. Cl. CPC F16K 21/18; F16K 31/122; B60K 2015/03296; B67D 7/362; B60K 15/03519; F16K 17/24

(57) ABSTRACT

The present invention is directed broadly to a tank overfill protection system (10) generally comprising a flow control valve (12) operatively coupled to a tank level sensor via a pilot line (16). The flow control valve (12) generally comprises: 1. a valve body (26) defining a fluid passageway (28) between a fluid inlet (30) and a fluid outlet (32); 2. a piston (34) slidably mounted within the fluid passageway (28) and arranged for displacement for opening and closure of the fluid outlet (32); 3. a bleed fluid cavity (36) located within the valve body (26) and arranged to cooperate with the piston (34); 4. a bleed fluid conduit (38) operatively coupled to the bleed fluid cavity (36); 5. a venturi arrangement (40) operatively coupled to the bleed fluid conduit (38) to promote evacuation of bleed fluid from the bleed fluid cavity (36) thereby opening the fluid outlet (32) by displacement of the piston (34).

### TECHNICAL FIELD

The present invention related broadly to a flow control valve and relates particularly although not exclusively to a tank overfill protection system including a flow control valve operated by a pilot “signal” from an associated tank level sensor.

### BACKGROUND OF INVENTION

In order to save time in industrial refueling applications, flowrates over 100 litres per minute are often specified. One approach to refuel tanks is to use a pressurized tank shut off system. This system allows a tank to be refueled at atmospheric pressure until the level of fuel inside the tank trips a level sensor, and seals off the tank venting function. The tank continues filling and pressurizes until the pressure within the tank reaches a “set point” which causes the system to shut off. Repeated refueling cycles using this shut off system have the potential to cause tanks to fatigue. Additionally, manual override of pressurized tank shut off systems can introduce problems such as fuel spills and exacerbate the tank pressure. Further, the trend towards lower mass and lower cost fuel tanks onboard plant equipment such as mining vehicles has reduced the design pressure of such tanks, virtually mandating a “zero tank pressure” refueling system.

In order to address these shortcomings of pressurized tank shut off systems, an alternative “zero tank pressure” system has been developed by the applicant. This “zero tank pressure” system uses a combination of a level sensor, pilot line, and flow control valve to automatically shut off flow to the tank at a safe fill level. Operation of the flow control valve is based on a flow/no-flow condition of a pilot line connected into the flow control valve itself. This pilot line is connected to one or more level sensors which are designed to allow free flow through the pilot line until the fuel level within the tank reaches a set point. Once the set point is reached the level sensors are designed to restrict flow through the pilot line, and thereby shut the flow control valve.

International patent publication No. WO2015/103341 by Cooley discloses a flow control valve for use with a float valve and associated pilot circuit. The flow control valve is designed to be automatically shut off via the float valve/pilot circuit when the fuel level reaches an adequate fill level. The flow control valve is of a normally-closed configuration relying upon a spring to bias a valve plug closed. The valve plug reciprocates outside a guide support and together they define a pressure chamber within which the spring is contained. The control valve also includes a tubular valve plug guide along which the valve plug travels in opening and closing. The valve plug guide is in fluid communication with the pilot circuit and includes fluid apertures at the pressure chamber. The pilot circuit includes an aperture which acts as a “flow limiter” at an entrance to the control valve which provides a limited flow of fluid to the pilot circuit. On reaching an adequate fill level, the flow of bleed fluid through the pilot circuit is prevented whereby the fluid pressure in the pressure chamber increases to assist the spring in closing the valve plug.

### SUMMARY OF INVENTION

According to a first aspect of the present invention there is provided a flow control valve comprising:

a valve body defining a fluid passageway between a fluid inlet and a fluid outlet;

a piston slidably mounted within the fluid passageway and arranged for opening and closure of the fluid outlet;

a bleed fluid cavity at least in part located within the valve body and arranged to cooperate with the piston to, under the influence of bleed fluid pressure within the bleed fluid cavity, create a force imbalance across the piston to promote closure of the fluid outlet by displacement of the piston;

a bleed fluid conduit operatively coupled to the bleed fluid cavity for bleed fluid communication between said cavity and the bleed fluid conduit;

a venturi arrangement operatively coupled to the bleed fluid conduit to reduce pressure within the bleed fluid cavity to promote evacuation of the bleed fluid from said cavity thereby opening the fluid outlet by displacement of the piston.

Preferably the valve body includes a rear valve body within which the piston is slidably mounted, said rear body including one or more radial openings which at least in part define the fluid outlet. More preferably the piston includes a peripheral wall arranged to cooperate with the radial openings of the rear body for opening and closure of the fluid outlet. Still more preferably the peripheral wall of the piston internally defines a piston chamber which at least in part forms the bleed fluid cavity.

Preferably the piston includes an axial opening through which the bleed fluid conduit passes defining an annular bleed passage between the piston and the bleed fluid conduit, said bleed passage arranged to transfer bleed fluid to or from the fluid passageway and the bleed fluid cavity. More preferably the bleed fluid conduit includes one or more apertures located within the bleed fluid cavity and arranged to provide the bleed fluid communication between the bleed fluid cavity and the bleed fluid conduit.

Preferably the valve body also includes a front valve body defining at least part of the fluid passageway including the fluid inlet, said front valve body operatively coupled to a pilot line associated with the flow control valve. More preferably the valve body also includes a connector arranged to retain the rear valve body and adapted to connect to a tank with which the pilot line is associated.

Preferably the venturi arrangement is operatively coupled to the pilot line at the front valve body and located within the fluid passageway at the front valve body. More preferably the bleed fluid conduit connects the venturi arrangement within the front valve body to the bleed fluid cavity. Even more preferably the venturi arrangement is associated with a fluid sampling orifice which samples fluid at the fluid inlet for provision at the venturi arrangement which with fluid flow through the pilot line promotes evacuation of bleed fluid from the bleed fluid cavity via the bleed fluid conduit thus reducing pressure within the bleed fluid cavity to promote displacement of the piston and opening of the fluid outlet. Still more preferably the fluid sampling orifice on restricted fluid flow through the pilot line provides sampled fluid from the fluid inlet to the bleed fluid cavity via the venturi arrangement and the bleed fluid conduit to substantially equalise fluid pressure between the fluid sampling orifice and the bleed cavity whereby the force imbalance across the piston promotes displacement of the piston and closure of the fluid outlet. In this arrangement the pilot line with which the flow control valve is associated is located outside the tank.

Alternatively the venturi arrangement is located within the bleed fluid cavity and is operatively coupled to a pilot line at the rear valve body. In this alternative embodiment the venturi arrangement is associated with a fluid sampling orifice which samples fluid at the fluid passageway for provision at the venturi arrangement which with fluid flow through the pilot line promotes evacuation of bleed fluid from the bleed fluid cavity via the bleed conduit thus reducing pressure within said bleed cavity to promote displacement of the piston and opening of the fluid outlet. In this alternative embodiment the bleed fluid conduit is adapted to operatively couple to the pilot line located inside a tank with which the flow control valve is associated.

Preferably the piston includes a cylindrical portion defined by the peripheral wall, a seating portion connected to the cylindrical portion, and a substantially conical portion connected to the seating portion. More preferably the seating portion includes a radially extending seating face configured to seat with the rear valve body on closure of the fluid outlet via the piston. Even more preferably the fluid passageway is in a downstream flow direction tapered inwardly forming an annular shoulder including a radially extending seating face within the rear valve body configured for seating closure with the seating face of the seating portion of the piston. Still more preferably the seating face of the piston is formed by an annular rebate within the seating portion of the piston. Even still more preferably the piston is designed for staged closure of the fluid outlet where initially the annular shoulder of the rear valve body axially overlaps the annular rebate of the piston and subsequently, on complete closure of the fluid opening, the seating face of the rear body contacts the seating face in the piston. Still further more preferably the seating portion of the piston has a circumferential chamfer extending radially outward from the seating face of the piston reducing its contact area with the seating face of the rear valve body assisting with operation of the piston.

Preferably the front valve body is pivotally coupled to the connector for rotational movement relative to said connector for reorientation of the front valve body for substantial alignment with the pilot line. More preferably the valve includes a clasp assembly arranged to clasp the front valve body to the rear valve body for axial securement to one another whilst permitting pivotal movement of the front valve body relative to the connector. Even more preferably the clasp assembly includes a plurality of flange segments arranged to engage the front valve body, and a plurality of clasp fasteners arranged to engage both the connector and the plurality of flange segments for axial securement of the front and rear valve bodies to one another. Still more preferably the valve body further includes one or more locking elements arranged to engage both the front valve body and the clasp assembly to pivotally secure the front valve body relative to the connector.

According to a second aspect of the invention there is provided a flow control valve comprising:

a valve body defining a fluid passageway between opposing first and second fluid openings;

a piston slidably mounted within the fluid passageway and arranged for opening and closure of the second fluid opening;

a bleed fluid cavity at least in part located within the valve body and arranged to cooperate with the piston to, under the influence of bleed fluid pressure within the bleed fluid cavity, create a force imbalance across the piston to promote closure of the second fluid opening by displacement of the piston;

a bleed fluid conduit operatively coupled to the bleed fluid cavity for bleed fluid communication between said cavity and the bleed fluid conduit;

a venturi arrangement operatively coupled to the bleed fluid conduit to reduce pressure within the bleed fluid cavity to promote evacuation of the bleed fluid from said cavity thereby opening the second fluid opening by displacement of the piston.

Preferably the valve body is operatively coupled to a pilot line associated with the flow control valve. More preferably the venturi arrangement is associated with a fluid sampling orifice which samples fluid from either the first opening or the fluid passageway for provision at the venturi arrangement wherein: i) fluid flow from the venturi arrangement and through the pilot line in one direction promotes evacuation of bleed fluid from the bleed fluid cavity via the bleed fluid conduit thus reducing pressure within the bleed fluid cavity to promote displacement of the piston and opening of the second fluid opening, and ii) fluid flow from the pilot line and through the venturi arrangement in an opposite direction also promotes evacuation of bleed fluid from the bleed fluid cavity to promote opening of the second fluid opening. Even more preferably the flow control valve is arranged for bi-directional flow when fluid flows through the pilot line occurs in either said one or the opposite direction.

According to a third aspect of the invention there is provided a tank overfill protection system comprising:

a flow control valve adapted to operatively couple to a tank to be filled with fluid, said flow control valve comprising:
i) a valve body defining a fluid passageway between a fluid inlet and a fluid outlet;
ii) a piston slidably mounted within the fluid passageway and arranged for opening and closure of the fluid outlet;
iii) a bleed fluid cavity at least in part located within the valve body and arranged to cooperate with the piston to, under the influence of bleed fluid pressure within the bleed fluid cavity, create a force imbalance across the piston to promote closure of the fluid outlet by displacement of the piston;
iv) a bleed fluid conduit operatively coupled to the bleed fluid cavity for bleed fluid communication between said cavity and the bleed fluid conduit;
v) a venturi arrangement operatively coupled to the bleed fluid conduit to reduce pressure within the bleed fluid cavity to promote evacuation of the bleed fluid from said cavity thereby opening the fluid outlet by displacement of the piston;

a tank level sensor adapted to operatively couple to the tank, said level sensor connected to a pilot line associated with bleed fluid cavity of the flow control valve whereby the tank level sensor is arranged to detect a safe fill level within the tank and restrict bleed fluid flow through the pilot line promoting the force imbalance across the piston which is effective in displacement of the piston for closure of the fluid outlet of the flow control valve.

Preferably the tank level sensor comprises:

a valve body including a pilot inlet adapted to couple to the pilot line;

at least one pilot valve mounted to the valve body and in liquid communication with the pilot inlet;

a pilot valve actuator operatively coupled to said at least one pilot valve for its opening and closure, the pilot valve actuator including a balance member arranged to cooperate with actuator biasing means, the balance member having a specific gravity relative to liquid within the tank whereby at least part submersion of the balance member provides movement of the balance member relative to the valve body, said movement of the balance member:

i) only occurring together with the influence of the actuator biasing means;

and

ii) being effective in closure of said at least one pilot valve.
More preferably said at least one pilot valve includes at least one poppet valve having a poppet valve head connected to a valve stem arranged to be contacted by the balance member for opening of said at least one pilot valve. Even more preferably the actuator biasing means includes a pilot valve compression spring designed to provide sufficient biasing force to provide movement of the balance member relative to the valve body for:
i) closure of the poppet valve on at least part submersion of the balance member with the biasing force of the compression spring overcoming an apparent weight of the balance member;
ii) opening of the poppet valve when the balance member is not at least part submerged and the weight of the balance member overcomes the biasing force of the compression spring.

According to a fourth aspect of the invention there is provided a flow control valve comprising:

a valve body assembly including a rear valve body defining part of a fluid passageway including a fluid outlet, said valve body assembly including a connector arranged to retain the rear valve body;

a piston slidably mounted within the fluid passageway of the rear valve body and arranged for opening and closure of the fluid outlet;

a front valve body defining at least part of the fluid passageway including a fluid inlet, said front valve body pivotally coupled to the connector for rotational movement relative to said connector for reorientation of the front valve body.

Preferably the connector is adapted to connect to a tank, and the front valve body is operatively coupled to a pilot line associated with the flow control valve. More preferably the front valve body rotationally couples to the connector for reorientation relative to the connector for substantial alignment with the pilot line.

Preferably the flow control valve includes a clasp assembly arranged to clasp the front valve body to the rear valve body for axial securement to one another whilst permitting rotational movement of the front valve body relative to the connector. More preferably the clasp assembly includes a plurality of flange segments arranged to engage the front valve body, and a plurality of clasp fasteners arranged to engage both the connector and the flange segments for axial securement of the front and rear valve bodies to one another. Still more preferably the valve body further includes one or more locking elements arranged to engage both the front valve body and the clasp assembly to rotationally secure the front valve body relative to the connector.

### BRIEF DESCRIPTION OF DRAWINGS

In order to achieve a better understanding of the nature of the present invention a preferred embodiment of a flow control valve and a tank overfill protection system will now be described, by way of example only, with reference to the accompanying drawings in which:

FIG. 1 is a schematic illustration of a tank overfill protection system according to one aspect of the present invention generally comprising a flow control valve and a tank level sensor;

FIG. 2 is a schematic illustration of the tank overfill protection system of FIG. 1 in the course of refilling the associated tank with flow through a pilot line between the flow control valve and the tank level sensor;

FIG. 3 is a front perspective view of the flow control valve taken from FIGS. 1 and 2 according to another aspect of the invention and fitted within a tank shell;

FIG. 4 is a front perspective view of the flow control valve of the embodiment of FIG. 3;

FIG. 5 is a rear perspective view of the flow control valve of FIG. 4;

FIG. 6 is a cross-sectional view of the flow control valve of the preceding figures;

FIG. 7 is an exploded rear perspective view of the flow control valve of the preceding figures;

FIG. 8 is an enlarged cross-sectional view shown in perspective of an alternative venturi arrangement of a flow control valve of another embodiment of the invention;

FIG. 9 is an enlarged cross-sectional view of a further venturi arrangement of a flow control valve of a further embodiment of the invention;

FIG. 10 is a cross-sectional view shown in perspective of the flow control valve of the earlier embodiment depicting force imbalances;

FIGS. 11A to 11D are enlarged cross-sectional views of the flow control valve of the earlier embodiment showing its staged closure;

FIG. 12 is a cross-sectional view of the earlier embodiment of the flow control valve showing fluid flows in its open condition;

FIG. 13 is a flow diagram schematically showing flow through the flow control valve of FIG. 12 in its open condition;

FIG. 14 is a cross-sectional view of the earlier embodiment of the flow control valve showing fluid flows in its closed condition;

FIG. 15 is a flow diagram schematically illustrating flow through the flow control valve of FIG. 14 in its closed condition.

### DETAILED DESCRIPTION

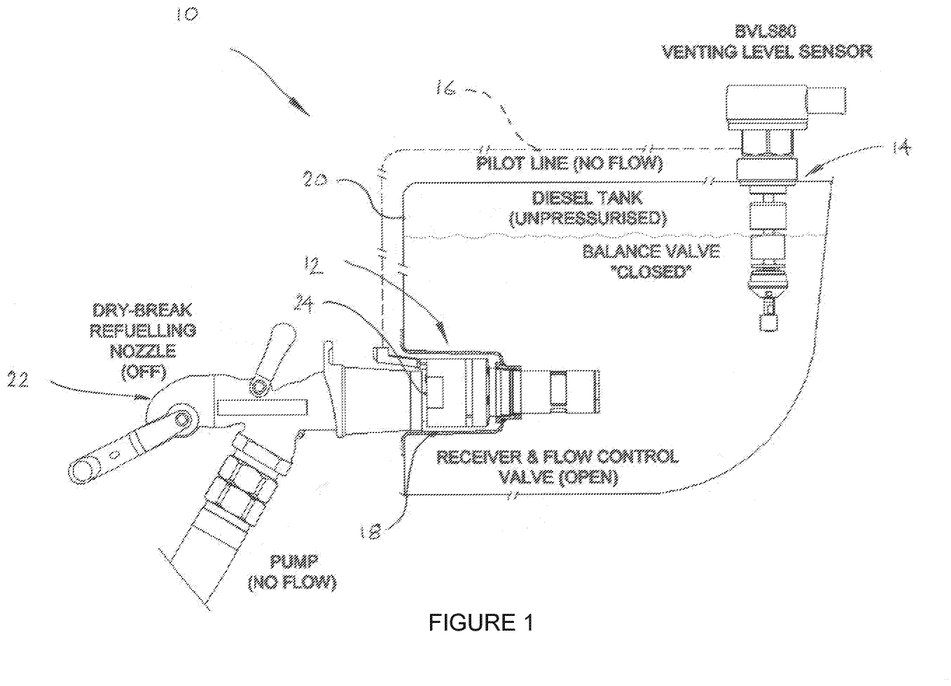

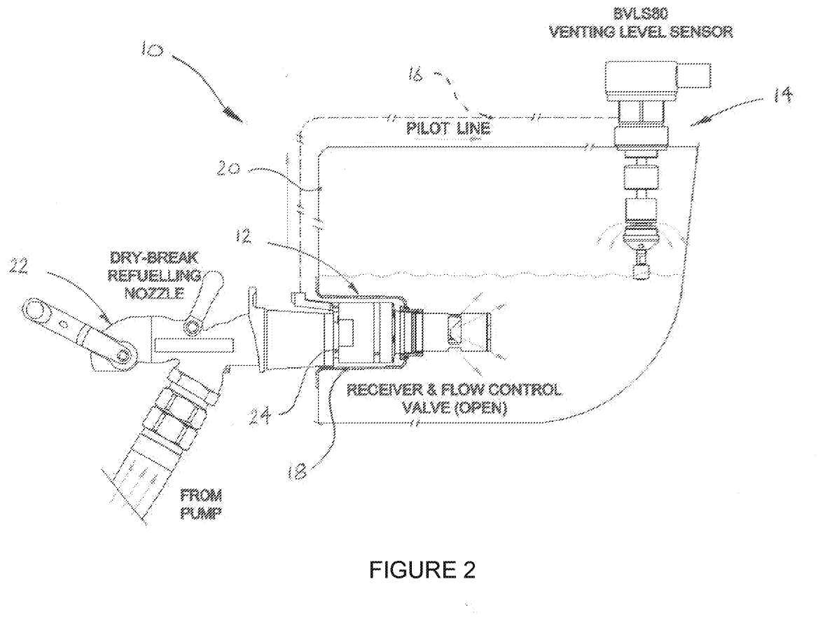

FIGS. 1 and 2 illustrate a tank overfill protection system 10 according to one aspect of the invention and generally comprising a flow control valve 12 operatively coupled to a tank level sensor 14 via a pilot line 16. In this embodiment the tank level sensor 14 is substantially identical to one or more of the embodiments disclosed in the applicant's international patent publication no. WO2018/053598. The contents of the specification of this international patent application are to be considered incorporated herein by way of this reference.

In this embodiment the flow control valve 12 is connected within a tank shell 18 fitted to a tank 20. The tank 20 is unpressurised and in this example contains a liquid such as diesel. The tank 20 is filled via a nozzle 22 which connects to a receiver 24 associated with the flow control valve 12. In operation the tank level sensor 14 is designed at a safe fill level within the tank 20 to restrict flow through the pilot line 16 and automatically close the flow control valve 12 to stop filling of the tank 20 via the nozzle 22, see FIG. 1. On the other hand, filling of the tank 20 up to the safe fill level is permitted with flow of fluid through the pilot line 16 with the tank level sensor 14 open and the flow control valve 12 thus automatically biased in its open condition.

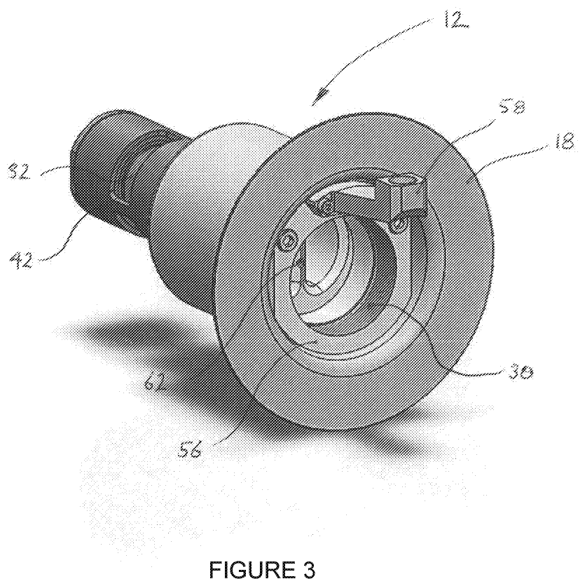

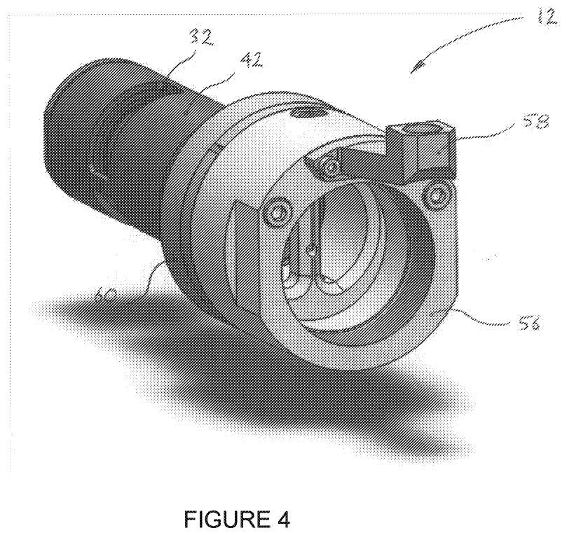

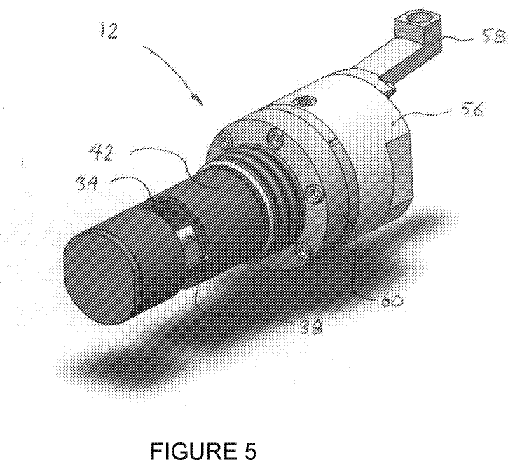

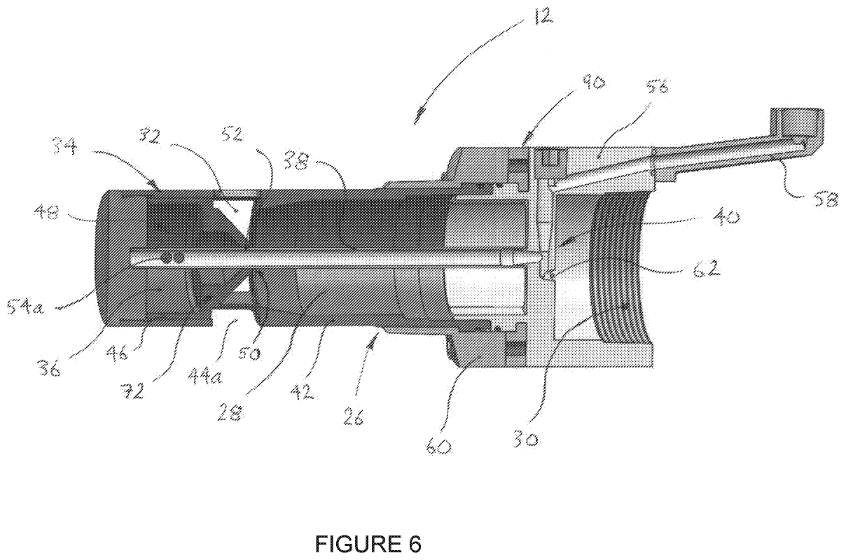

FIGS. 3 to 7 illustrates various views of the flow control valve 12 taken from the tank overfill protection system 10 of the earlier aspect of the invention. In this embodiment of the invention the flow control valve 12 generally comprises:
1. a valve body 26 defining a fluid passageway 28 between a fluid inlet 30 and a fluid outlet 32;
2. a piston 34 slidably mounted within the fluid passageway 28 and arranged for displacement for opening and closure of the fluid outlet 32;
3. a bleed fluid cavity 36 located within the valve body 26 and arranged to cooperate with the piston 34;
4. a bleed fluid conduit 38 operatively coupled to the bleed fluid cavity 36;
5. a venturi arrangement 40 operatively coupled to the bleed fluid conduit 38 to promote evacuation of bleed fluid from the bleed fluid cavity 36 thereby opening the fluid outlet 32 by displacement of the piston 34.

In this embodiment the valve body 26 includes a rear valve body 42 within which the piston 34 is slidably mounted, the rear valve body 42 including one or more radially openings such as 44a which at least in part define the fluid outlet 32. In this example the piston 34 includes a peripheral wall 46 being shaped substantially cylindrical and arranged to i) cooperate with the radial openings such as 44a of the rear body 42 for opening and closure of the fluid outlet 32, and ii) internally define a piston chamber 48 which at least in part forms the bleed fluid cavity 36.

In this embodiment the piston 34 includes an axial opening 50 through which the bleed fluid conduit 38 passes defining an annular bleed passage 52 between the piston 34 and the bleed fluid conduit 38. The annular bleed passage 52 is designed to provide bleed fluid from the fluid passageway 28 to the bleed fluid cavity 36. The bleed fluid conduit 38 includes one or more apertures such as 54a located within the bleed fluid cavity 36 and arranged to provide bleed fluid communication between the bleed fluid cavity 36 and the bleed fluid conduit 38.

The valve body 26 of this example also includes a front valve body 56 defining at least part of the fluid passageway 28 and including the fluid inlet 30. The front valve body 56 is operatively coupled to a pilot line such as 16 (see FIGS. 1 and 2) via a pilot spigot 58 mounted to the front valve body 56. The valve body 26 also includes a connector 60 arranged to retain the rear valve body 42 and adapted to mount to a tank such as 20 with which the pilot line 16 is associated.

Importantly the venturi arrangement 40 is operatively coupled to the pilot line 16 and in this embodiment is located within the fluid passageway 28 at the front valve body 56. The bleed conduit 38 connects the bleed fluid cavity 36 within the rear valve body 42 to the venturi arrangement 40 within the front valve body 56. The venturi arrangement 40 is associated with a fluid sampling orifice 62 which samples fluid at or adjacent the fluid inlet 30 for provision to the venturi arrangement 40. With fluid flowing through the pilot line such as 16 in one direction, the venturi arrangement 40 promotes evacuation of bleed fluid from the bleed fluid cavity 36 via the bleed fluid conduit 38 thus reducing pressure within the bleed fluid cavity 36 for opening of the fluid outlet 32 by displacement of the piston 34. With restricted or no fluid flow through the pilot line 16, sampled fluid from the fluid sampling orifice 62 is provided to the bleed fluid cavity 36 at a rear of the piston 34, via the venturi arrangement 40 and the bleed fluid conduit 38, substantially equalising fluid pressure at the rear of the piston 34 relative to the stagnation pressure measured at the sampling orifice 62. During closure of the control valve 12, the fluid pressure is substantially equalised on either side of the piston 34. This equalisation of pressure on closure of the piston 34 together with the difference in the projected area of the piston 34 at the front and the rear creates a force imbalance across the piston 34 to promote closure of the fluid outlet 32 by displacement of the piston 34.

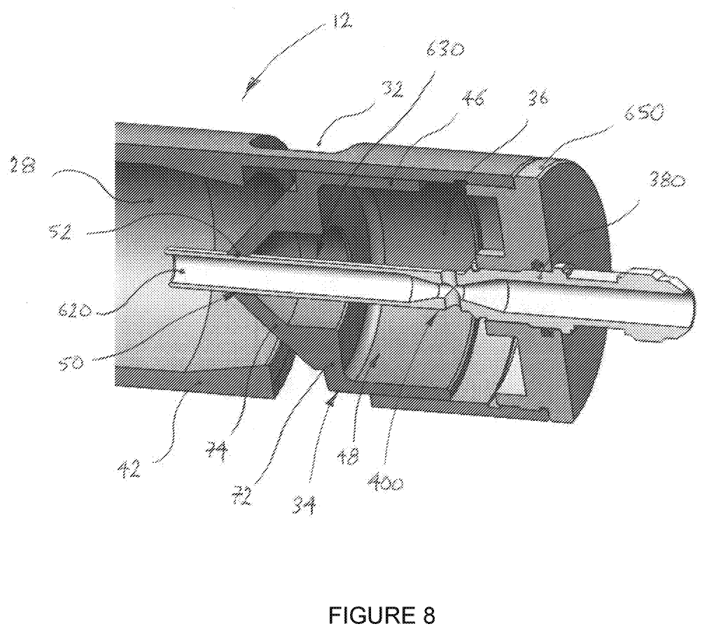

FIG. 8 illustrates an alternative embodiment of the venturi arrangement 400 operatively coupled to a pilot line (not shown) at the rear valve body 42. For ease of reference and in order to avoid repetition, corresponding components of this alternative embodiment have been designated with the same reference numeral. The venturi arrangement 400 is located within the bleed fluid cavity 36 at the rear valve body 42. The venturi arrangement 400 is associated with a fluid sampling orifice 620 which samples fluid at the fluid passageway 28 and delivers it to the venturi arrangement 400 via a fluid sampling tube 630. The venturi arrangement 400 is connected to the pilot line via bleed fluid conduit 380 which passes through end cap 650 fitted to the rear valve body 42. With fluid flow through the pilot line 160, this alternative venturi arrangement 400 promotes evacuation of bleed fluid from the bleed fluid cavity 36 via the bleed fluid conduit 380 thus reducing pressure within the bleed cavity 36 to promote opening of the fluid outlet 32 by displacement of the piston 34. The bleed fluid conduit 380 may be operatively coupled to a pilot line located either inside or outside a tank with which the flow control valve 12 is associated.

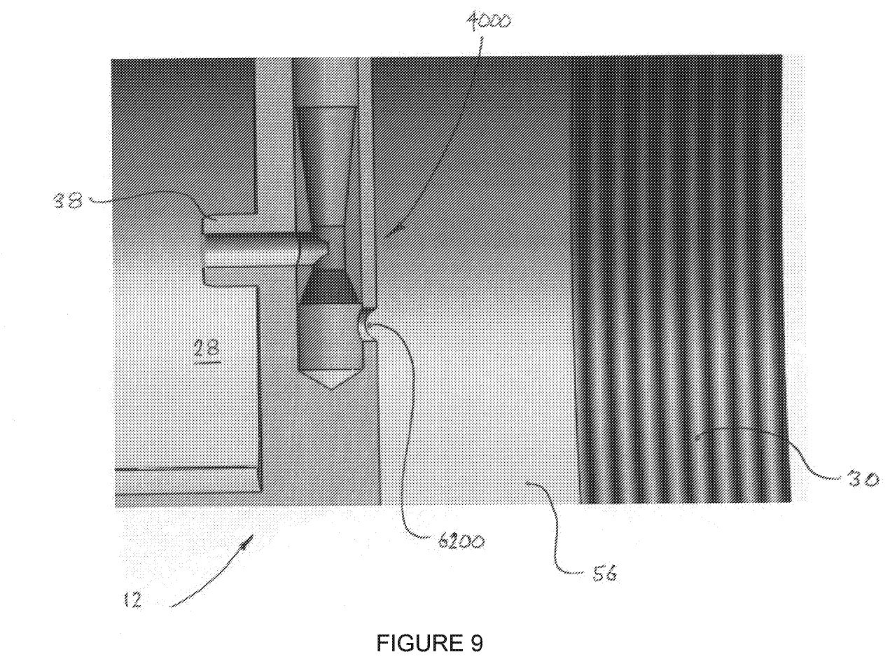

FIG. 9 illustrates a further variation of the venturi arrangement 4000 located within the fluid passageway 28 at the front valve body 56 and having an internal geometry suited to fluid flow through the pilot line such as 16 in an opposite direction. In this configuration the venturi arrangement 4000 is associated with a fluid sampling orifice 6200 which samples fluid from the fluid inlet 30 for provision at the venturi arrangement 4000 wherein:
1. fluid flow from the venturi arrangement 4000 and through the pilot line in one direction promotes evacuation of bleed fluid from the bleed fluid cavity via the bleed fluid conduit such as 38 thus reducing pressure within the bleed fluid cavity to promote displacement of the piston and opening of the fluid outlet;
2. fluid flow from the pilot line and through the venturi arrangement 4000 in an opposite direction also promotes evacuation of bleed fluid from the bleed fluid cavity to promote displacement of the piston and opening of the fluid outlet.

The flow control valve 12 can also be bi-directional and when open operates with fluid flow through the passageway 28 in either direction where fluid flows from the fluid inlet 30 to the fluid outlet 32 or vice versa. Fluid flow through the pilot line in the opposite direction for opening of the valve may be motivated by applying hydraulic fluid pressure to the pilot line via a pump or other device. Alternatively, fluid flow through the pilot line in said one direction for opening of the valve may be motivated by applying a vacuum to the pilot line. In either case, the pilot line is “artificially” energised by an external fluid source which promotes flow through the pilot line in either direction thereby opening the piston. This may have application in draining a tank associated with the flow control valve where flow through the pilot line opens the control valve for reverse fluid flow from the outlet to the inlet of the control valve for draining of the tank. The flow control valve can thus be activated externally via the pilot line without mechanically actuating the control valve itself.

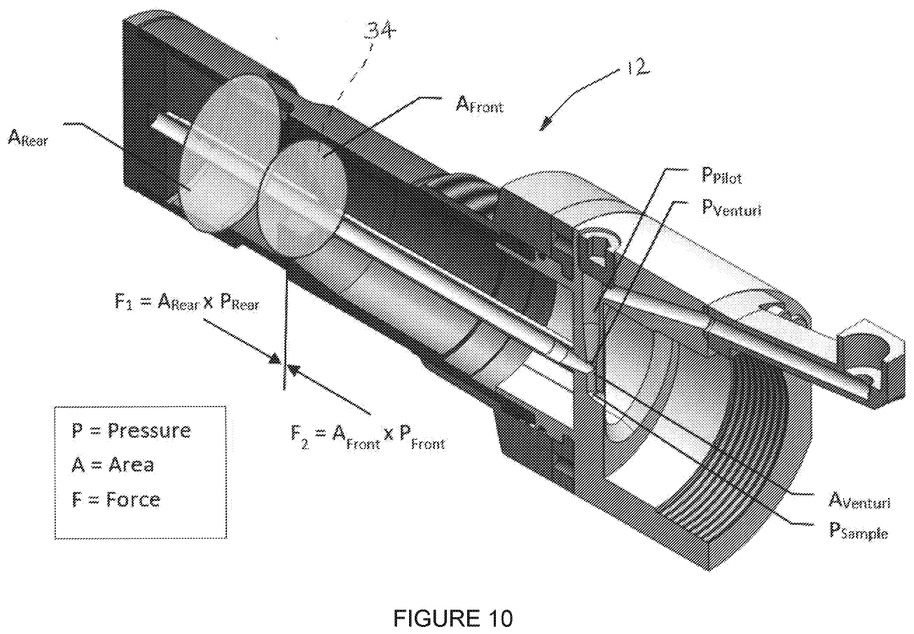

As seen in FIG. 10, the piston 34 is designed so that its projected area at the front (A_{Front}) exposed to fluid pressure varies with the position of the piston 34. During operation, the major forces acting on the piston 34 result from the pressures at the front and rear of the piston 34 acting across the front projected area and its rear projected area (A_{Rear}) exposed to fluid pressure. It can be seen that during closure of the piston 34 the front projected area is smaller than the rear projected area and with substantially equal pressure on either side of the piston 34 the force on the rear of the piston (F₁) is greater than the force on the front of the piston (F₂). That is, a force imbalance is created across the piston 34 which promotes its closure.

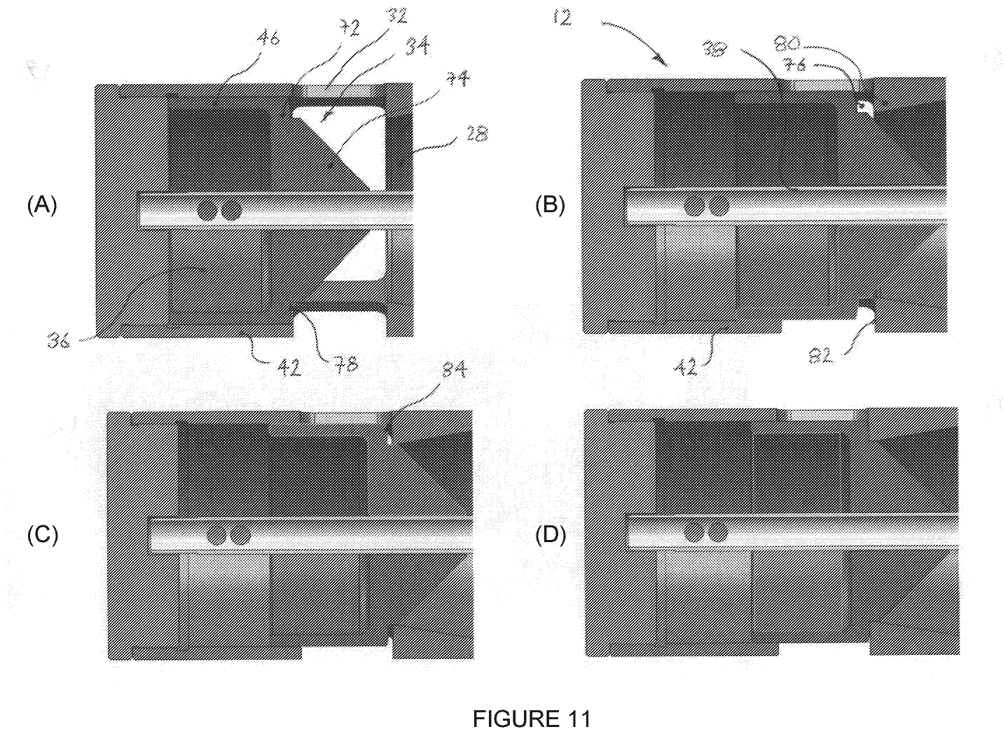

As seen in FIGS. 11A to 11D the piston 34 of this embodiment includes a cylindrical portion defined by the peripheral wall 46, and a seating portion 72 connected to the cylindrical wall 46. The piston 34 also includes a substantially conical portion 74 connected to the seating portion 72 which includes an annular rebate 76. The annular rebate or step 76 defines a radially extending face 78 configured for seating closure with the rear body 42. The fluid passageway 28 within the rear body 42 is in a downstream flow direction tapered inwardly to form an annular shoulder 80. The annular shoulder 80 includes a radially extending seating face 82 with which the radially extending seating face 78 of the piston 34 seats for closure. The seating portion 78 of the piston 34 has a circumferential chamfer 84 extending radially outward from the seating face 78 of the piston 34. This circumferential chamfer 84 reduces the contact area of the piston 34 with the seating face 82 of the rear valve body 42.

As seen in FIG. 11A, when the piston 34 is fully opened the projected areas on the front and rear of the piston 34 that are exposed to pressure are substantially equal. When the pilot line associated with the flow control valve is exposed to restricted flow, the pressure at the front of the piston 34 is initially quite low relative to the static pressure that is developed at the rear of the piston 34 within the bleed fluid cavity 36. This is because the fluid in front of the piston 34 is freely discharging from the fluid passageway 28 via the fluid outlet 32 while the sampling orifice via the bleed fluid conduit 38 is converting most of its dynamic pressure into static pressure within the bleed fluid cavity 36.

As illustrated in FIG. 11B, as the piston 34 moves for closure of the fluid outlet 32 this discharge restriction from the fluid passageway 28 maintains significant discharge losses. While the projected areas to the front and rear of the piston 34 are now equal, the pressure acting on the front of the piston 34 is still reduced by the partial fluid flow from the fluid passageway 28. However, the pressure acting on the rear of the piston 34 now approaches the stagnation pressure at the sampling orifice. The stagnation pressure at the rear of the piston 34 within the bleed fluid cavity 36 is greater than the static pressure at the front of the piston 34 within the fluid passageway 28.

As depicted in FIG. 11C, the piston 34 moves wherein the annular shoulder 80 of the rear valve body 42 axially overlaps the annular rebate or step 76 of the piston 34. The fluid outlet 32 is thus restricted wherein the effective projected area of the front of the piston 34 is now reduced to the area of the fluid passageway 28 within the smallest diameter portion of the annular shoulder 80 i.e. the projected area of the conical portion 74 of the piston 34. At this stage of closure, discharge losses begin to increase toward the deadhead pressure of the fluid system and pressure distribution within the front and rear of the piston 34 tends to uniformly increase with a mostly even pressure distribution on the front and rear of the piston 34. The increased relative effective area of the rear of the piston 34 amplifies the force imbalance and promotes closure of the fluid outlet 32 via the piston 34. The annular rebate or step 76 in the piston 34 means the fluid passageway 28 can be maintained in a restricted flow state even with slight axial displacement of the piston. This is specifically designed to substantially eliminate “chattering” caused by piston 34 vibration whereas in this embodiment any fluid that escapes the fluid outlet 32 at this stage of closure is immediately reduced to tank pressure.

As shown in FIG. 11D, on complete closure of the fluid outlet 32, the radially extending seating face 78 of the piston 34 is pressed against the seating face 82 of the annular shoulder 80 of the rear body 42. The clearance fit between the piston 34 and the rear body 42 allows fluid leakage from the bleed fluid cavity 36 to the fluid outlet 32 and concurrently fluid from the fluid passageway 28 is bled into the bleed fluid cavity 36 via the annular bleed passage 52. In its fully closed condition the pressure developed on the rear of the piston 34 is equal to the pressure developed by frictional losses induced by the leakage from the bleed fluid cavity 36. The piston 34 is in this embodiment sized wherein the difference between stagnation pressure and friction leakage losses is offset by the larger effective projected area on the rear of the piston 34.

As described earlier, the chamfer 84 in the piston 34 reduces the area that the seating faces 78 and 82 contact each other thereby:
1. increasing the sealing pressure acting on these seating faces 78 and 82;
2. quickly expelling any leaked fluid between the sealing faces 78 and 82;
3. ensuring that the front face of the piston 34 which could be exposed to valve pressure will always have less projected area than the rear of the piston 34 when the piston 34 is closed.

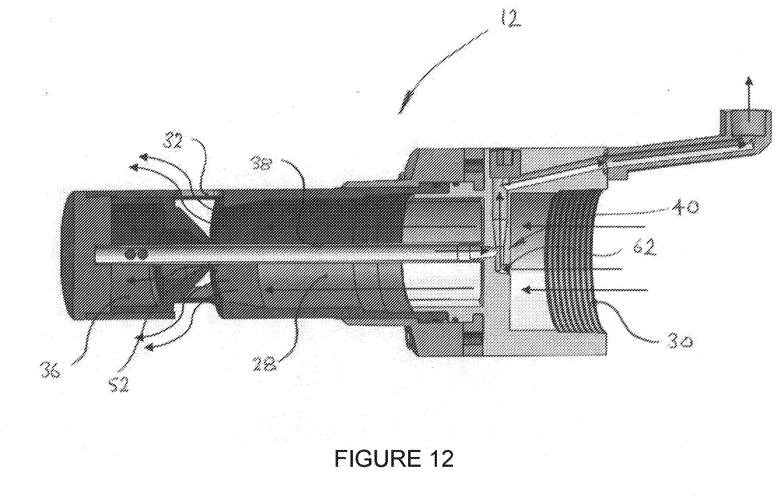

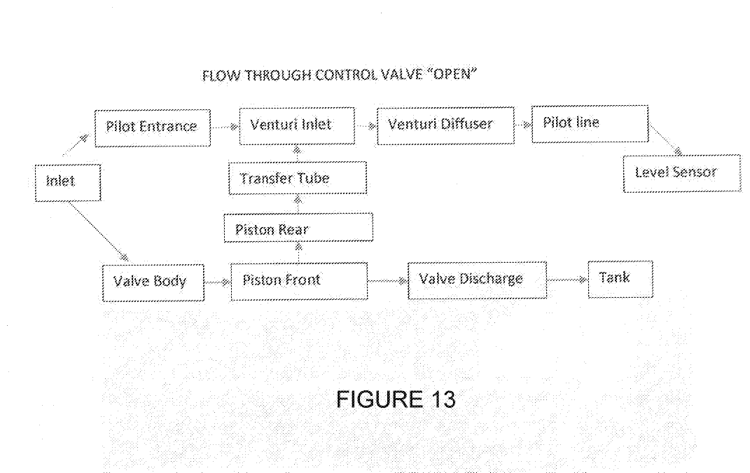

FIG. 12 illustrates fluid flows through the flow control valve 12 of the earlier embodiment in its open condition. The fluid flows through the flow control valve 12 in this open condition are schematically depicted in FIG. 13 where:
1. fluid from the fluid inlet 30 is sampled at the orifice 62 for entry to the venturi 40 and discharge to the associated pilot line and level sensor;
2. fluid from the inlet 30 flows through the fluid passageway 28 to the bleed fluid cavity 36 via the annular bleed passage 52 where under reduced pressure it is drawn via the venturi 40 through the bleed fluid conduit 38 for discharge to the pilot line;
3. fluid from the fluid inlet 30 flows through the fluid passageway 28 and exits the valve 12 via the fluid outlet 32 for discharge to the tank.

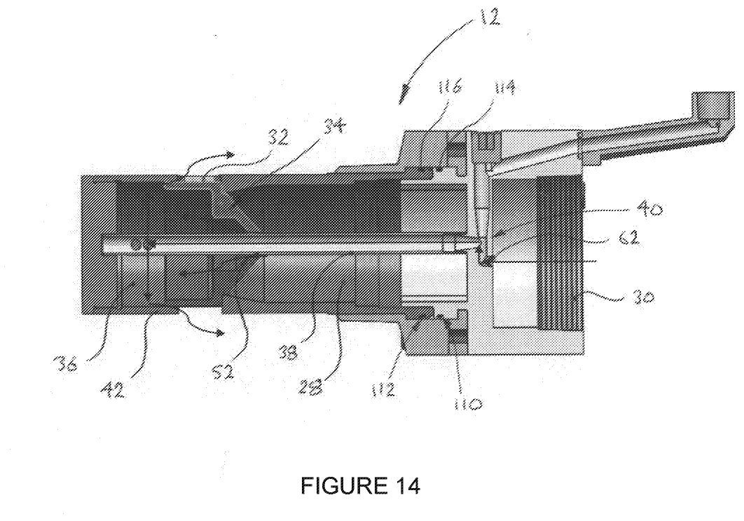

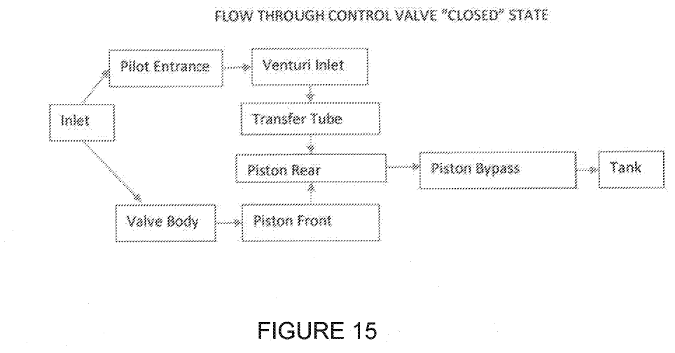

FIG. 14 illustrates fluid flows through the flow control valve 12 of the preferred embodiment in its closed condition. The fluid flows through the flow control valve 12 in this closed condition as schematically shown in FIG. 15 where:
1. fluid from the fluid inlet 30 is sampled at the orifice 62 flowing to the bleed fluid cavity 36 via the venturi arrangement 40 and the bleed fluid conduit 38, escaping the bleed fluid cavity 36 to the fluid outlet 32 and tank via the clearance fit between the piston 34 and the rear valve body 42;
2. fluid from the fluid inlet 30 flows through the fluid passageway 28 and into the bleed fluid cavity 36 via the annular bleed passage 52, escaping the flow control valve 12 via the clearance fit between the piston 34 and the rear valve body 42.

In another aspect of the invention as best seen in FIGS. 3 to 7 there is a flow control valve 12 where the front valve body 56 is rotationally coupled to the connector 60 for rotational movement relative to the connector 60. This rotational movement during installation of the flow control valve 12 permits reorientation of the front valve body 56 for substantial alignment of a pilot line such as 16 with the front valve body 56 and more particularly the pilot spigot 58. It will be understood that the connector 60 is screw threaded or otherwise connected to a tank such as 20 via an associated tank shell 18.

In this embodiment of this aspect of the invention the flow control valve 12 includes a clasp assembly 90 arranged to clasp the front valve body 56 to the rear valve body 42 for axial securement to one another whilst permitting rotational movement of the front valve body 56 relative to the connector 60. The clasp assembly 90 includes a plurality of flange segments such as 92a arranged to engage the front valve body 56 and a plurality of clasp fasteners such as 94a arranged to engage both the connector 60 and the plurality of flange segments such as 92a for axial securement of the front and rear valve bodies 56 and 42 to one another. In this example the clasp fastener 94a is one of six clasp fasteners 94a to 94f located within respective fastener openings 96a to 96f of the connector 60 and designed to threadingly engage respective of threaded fastener openings 98a to 98f formed in the clasp assembly 90. The pair of flange segments 92a and 92b are substantially identical including an internal annular flange such as 99a configured to engage a corresponding recess 100 formed in the front valve body 56.

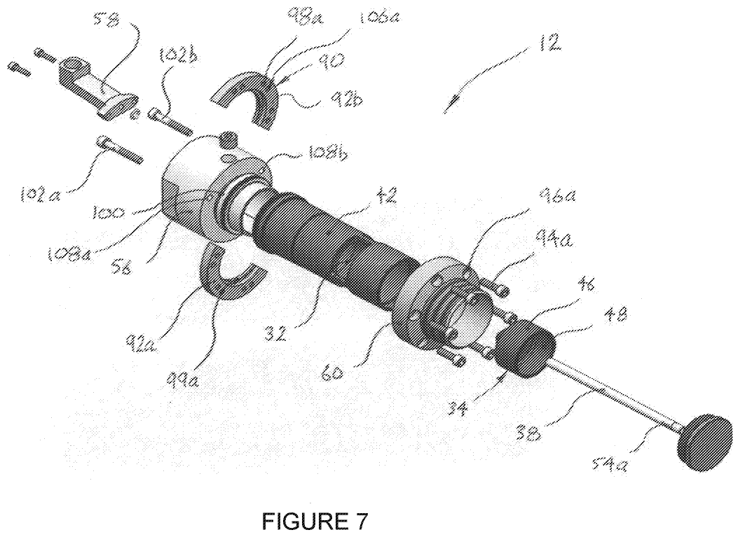

As best seen in FIG. 7, the valve body 26 also includes one or more locking elements in the form of locking screws 102a and 102b arranged to engage both the front valve body 56 and the clasp assembly 90 to rotationally secure the front valve body 56 to the connector 60. The clasp assembly 90 of this example includes six threaded apertures 106a to 106f equally spaced circumferentially about the pair of flange segments 92a and 92b. The locking screws 102a/b pass through a pair of corresponding screw apertures 108a/b in the front valve body 56 and selectively align for threaded engagement with two of the six threaded apertures 106a to 106f formed in the clasp assembly 90. In this example the front valve body 56 can thus be pivoted or rotated through 60 degree increments for reorientation of the front valve body 56 depending on its required position for alignment with the associated pilot line. The front valve body 56 is then rotationally secured relative to the connector 60 and thus the associated tank via the locking screws 102a/b. Each of the front valve body 56 and rear valve body 42 include circumferential grooves 110 and 112 on their external surface designed to accommodate O-ring seals 114 and 116 respectively. These seals 114 and 116 cooperate with an internal surface of the connector 60 to prevent fluid leakage from the tank via the clearance interface between the connector 60 and the rear valve body 42 and the front valve body 56.

Returning to FIG. 10, it is to be understood that the static pressure at the front of the piston, P_{front} can be determined by the summation of: discharge losses which occur through the rear body, and local tank pressure (both hydrostatic and static). Similarly, the dynamic and static pressure components (stagnation pressure) measured at Pₛₐₘₚₗₑ can be determined by the summation of P_{front}, the frictional losses between the sample point and rear body and the velocity pressure component of fluid flowing through the Sample Point itself. Otherwise, the pressures developed within the flow control valve are determined by a number of factors including, flowrate, tank hydrostatic pressure, tank geometry, and temperature. Notwithstanding these factors, the two key factors which control the relationship between P_{Front} and P_{Rear} are:

i) the flow condition and pressure within the pilot line; and
ii) the position of the piston.

Now that several preferred embodiments of the flow control valve and tank overfill protection system have been described it will be apparent to those skilled in the art that they have at least the following advantages:
1. the flow control valve including the venturi arrangement increases the pressure differential on opposing sides of the associated piston thereby remaining open when there is flow through the associated pilot line;
2. the flow control valve with restricted flow through the associated pilot line reverses the pressure differential across the piston promoting its displacement and closure of the valve;
3. the flow control valve and specific piston configuration of the preferred embodiment provides staged closure of the valve reducing the likelihood of “chatter” on valve closure;
4. the venturi of the flow control valve reduces the likelihood of foreign particles collecting within the piston chamber of the preferred embodiment by promoting bleed fluid flow away from said chamber;
5. the flow control valve lends itself to alignment with a pilot line during installation wherein the connector and rear valve body cooperate to permit rotational movement of the front valve body.

Those skilled in the art will appreciate that the invention as described herein is susceptible to variations and modifications other than those specifically described. For example, the piston may depart from its preferred shape provided in cooperation with the venturi arrangement it provides effective closure and opening of the fluid outlet. Similarly, the piston and bleed fluid conduit may be reconfigured without the annular bleed passage of the preferred embodiment provided bleed fluid is effectively supplied to the piston to create the force imbalance required for its displacement and resulting closure of the fluid outlet. The preferred construction of the front valve body and rear valve body in conjunction with the connector may vary where for example locking of the front valve body to the connector provides potentially an infinite number of angular dispositions for the front body for alignment with the associated pilot line. The flow control valve may be directly connected to the tank or indirectly connected in a remote installation to the tank via an intermediate coupling line. All such variations and modifications are to be considered within the scope of the present invention the nature of which is to be determined from the foregoing description.

1. A flow control valve comprising:
a valve body defining a fluid passageway between a fluid inlet and a fluid outlet;
a piston slidably mounted within the fluid passageway and arranged for opening and closure of the fluid outlet;
a bleed fluid cavity at least in part located within the valve body and arranged to cooperate with the piston to, under the influence of bleed fluid pressure within the bleed fluid cavity, create a force imbalance across the piston to promote closure of the fluid outlet by displacement of the piston;
a bleed fluid conduit operatively coupled to the bleed fluid cavity for bleed fluid communication between said cavity and the bleed fluid conduit;
a venturi arrangement operatively coupled to the bleed fluid conduit to reduce pressure within the bleed fluid cavity to promote evacuation of the bleed fluid from said cavity thereby opening the fluid outlet by displacement of the piston.

2. The flow control valve as claimed in claim 1 wherein the valve body includes a rear valve body within which the piston is slidably mounted, said rear body including one or more radial openings which at least in part define the fluid outlet.

3. The flow control valve as claimed in claim 2 wherein the piston includes a peripheral wall arranged to cooperate with the radial openings of the rear body for opening and closure of the fluid outlet, the peripheral wall of the piston internally defining a piston chamber which at least in part forms the bleed fluid cavity.

4. (canceled)

5. The flow control valve as claimed in claim 1 wherein the piston includes an axial opening through which the bleed fluid conduit passes defining an annular bleed passage between the piston and the bleed fluid conduit, said bleed passage arranged to transfer bleed fluid to or from the fluid passageway and the bleed fluid cavity.

6. (canceled)

7. The flow control valve as claimed in claim 1 wherein the valve body also includes a front valve body defining at least part of the fluid passageway including the fluid inlet, said front valve body operatively coupled to a pilot line associated with the flow control valve, valve body also including a connector arranged to retain the rear valve body and adapted to connect to a tank with which the pilot line is associated.

8. (canceled)

9. The flow control valve as claimed in claim 8 wherein the venturi arrangement is operatively coupled to the pilot line at the front valve body and located within the fluid passageway at the front valve body, the bleed fluid conduit connecting the venturi arrangement within the front valve body to the bleed fluid cavity.

10. (canceled)

11. The flow control valve as claimed in claim 7 wherein the venturi arrangement is associated with a fluid sampling orifice which samples fluid at the fluid inlet for provision at the venturi arrangement which with fluid flow through the pilot line promotes evacuation of bleed fluid from the bleed fluid cavity via the bleed fluid conduit thus reducing pressure within the bleed fluid cavity to promote displacement of the piston and opening of the fluid outlet, the fluid sampling orifice on restricted fluid flow through the pilot line providing sampled fluid from the fluid inlet to the bleed fluid cavity via the venturi arrangement and the bleed fluid conduit to substantially equalise fluid pressure between the fluid sampling orifice and the bleed cavity whereby the force imbalance across the piston promotes displacement of the piston and closure of the fluid outlet.

12-16. (canceled)

17. The flow control valve as claimed in claim 3 wherein the piston includes a cylindrical portion defined by the peripheral wall, a seating portion connected to the cylindrical portion, and a substantially conical portion connected to the seating portion including a radially extending seating face configured to seat with the rear valve body on closure of the fluid outlet via the piston.

18. (canceled)

19. The flow control valve as claimed in claim 17 wherein the fluid passageway is in a downstream flow direction tapered inwardly forming an annular shoulder including a radially extending seating face within the rear valve body configured for seating closure with the seating face of the seating portion of the piston, the seating face of the piston formed by an annular rebate within the seating portion of the piston.

20. (canceled)

21. The flow control valve as claimed in claim 19 wherein the piston is designed for staged closure of the fluid outlet where initially the annular shoulder of the rear valve body axially overlaps the annular rebate of the piston and subsequently, on complete closure of the fluid opening, the seating face of the rear body contacts the seating face in the piston.

22. The flow control valve as claimed in claim 19 wherein the seating portion of the piston has a circumferential chamfer extending radially outward from the seating face of the piston reducing its contact area with the seating face of the rear valve body assisting with operation of the piston.

23. The flow control valve as claimed in claim 7 wherein the front valve body is pivotally coupled to the connector for rotational movement relative to said connector for reorientation of the front valve body for substantial alignment with the pilot line, the valve including a clasp assembly arranged to clasp the front valve body to the rear valve body for axial securement to one another whilst permitting pivotal movement of the front valve body relative to the connector.

24. (canceled)

25. The flow control valve as claimed in claim 23 wherein the clasp assembly includes a plurality of flange segments arranged to engage the front valve body, and a plurality of clasp fasteners arranged to engage both the connector and the plurality of flange segments for axial securement of the front and rear valve bodies to one another.

26-30. (canceled)

31. A tank overfill protection system comprising:
a flow control valve adapted to operatively couple to a tank to be filled with fluid, said flow control valve comprising:
i) a valve body defining a fluid passageway between a fluid inlet and a fluid outlet;
ii) a piston slidably mounted within the fluid passageway and arranged for opening and closure of the fluid outlet;
iii) a bleed fluid cavity at least in part located within the valve body and arranged to cooperate with the piston to, under the influence of bleed fluid pressure within the bleed fluid cavity, create a force imbalance across the piston to promote closure of the fluid outlet by displacement of the piston;
iv) a bleed fluid conduit operatively coupled to the bleed fluid cavity for bleed fluid communication between said cavity and the bleed fluid conduit;
v) a venturi arrangement operatively coupled to the bleed fluid conduit to reduce pressure within the bleed fluid cavity to promote evacuation of the bleed fluid from said cavity thereby opening the fluid outlet by displacement of the piston;
a tank level sensor adapted to operatively couple to the tank, said level sensor connected to a pilot line associated with bleed fluid cavity of the flow control valve whereby the tank level sensor is arranged to detect a safe fill level within the tank and restrict bleed fluid flow through the pilot line promoting the force imbalance across the piston which is effective in displacement of the piston for closure of the fluid outlet of the flow control valve.

32. The tank overfill protection system as claimed in claim 31 wherein the tank level sensor comprises:
a valve body including a pilot inlet adapted to couple to the pilot line;
at least one pilot valve mounted to the valve body and in liquid communication with the pilot inlet;
a pilot valve actuator operatively coupled to said at least one pilot valve for its opening and closure, the pilot valve actuator including a balance member arranged to cooperate with actuator biasing means, the balance member having a specific gravity relative to liquid within the tank whereby at least part submersion of the balance member provides movement of the balance member relative to the valve body, said movement of the balance member:
i) only occurring together with the influence of the actuator biasing means; and
ii) being effective in closure of said at least one pilot valve.

33. The tank overfill protection system as claimed in claim 32 wherein said at least one pilot valve includes at least one poppet valve having a poppet valve head connected to a valve stem arranged to be contacted by the balance member for opening of said at least one pilot valve.

34. The tank overfill protection system as claimed in claim 33 wherein the actuator biasing means includes a pilot valve compression spring designed to provide sufficient biasing force to provide movement of the balance member relative to the valve body for:
i) closure of said at least one poppet valve on at least part submersion of the balance member with the biasing force of the compression spring overcoming an apparent weight of the balance member;
ii) opening of said at least one poppet valve when the balance member is not at least part submerged and the weight of the balance member overcomes the biasing force of the compression spring.

35. A pilot-operated flow control valve comprising:
a valve body assembly including a rear valve body defining part of a fluid passageway including a fluid outlet, said valve body assembly including a connector arranged to retain the rear valve body;
a piston slidably mounted within the fluid passageway of the rear valve body and arranged for opening and closure of the fluid outlet;
a front valve body defining at least part of the fluid passageway including a fluid inlet, said front valve body i) operatively coupled to an external pilot line associated with said flow control valve, and ii) pivotally coupled to the connector for rotational movement of said front valve body relative to said connector for reorientation of the front valve body for substantial alignment with the external pilot line.

36. (canceled)

37. The pilot-operated flow control valve as claimed in claim 35 wherein the valve includes a clasp assembly arranged to clasp the front valve body to the rear valve body for axial securement to one another whilst permitting rotational movement of the front valve body relative to the connector.

38. The pilot-operated flow control valve as claimed in claim 37 wherein the clasp assembly includes a plurality of flange segments arranged to engage the front valve body, and a plurality of clasp fasteners arranged to engage both the connector and the flange segments for axial securement of the front and rear valve bodies to one another.

39. (canceled)
